(19) United States
(12) Patent Application Publication
(10) Pub. No.: US 2025/0355598 A1
(43) Pub. Date: Nov. 20, 2025

(54) METHOD AND APPARATUS FOR DOUBLE-WRITING BASED ON WRITE-AHEAD

(71) Applicant: Korea Advanced Institute of Science and Technology, Daejeon (KR)

(72) Inventors: Youjip Won, Daejeon (KR); Jieun Kim, Daejeon (KR)

(73) Assignee: Korea Advanced Institute of Science and Technology, Daejeon (KR)

(21) Appl. No.: 19/291,371

(22) Filed: Aug. 5, 2025

Related U.S. Application Data
(63) Continuation of application No. PCT/KR2024/001405, filed on Jan. 30, 2024.

(30) Foreign Application Priority Data
Feb. 15, 2023 (KR) 10-2023-0020158
Jan. 26, 2024 (KR) 10-2024-0012263

(51) Int. Cl. G06F 3/06

(52) U.S. Cl. CPC G06F 3/0659; G06F 3/0613; G06F 3/0643; G06F 3/0674

(57) ABSTRACT

The present disclosure relates to a method and apparatus for double-writing based on write-ahead, which may be configured to: classify write requests for different streams into write-ahead and write-behind on the basis of sequence constraints; transform write-ahead into double-writing for the streams; and log the streams in compliance with the sequence constraints on the basis of the double-writing.

### CROSS-REFERENCE TO RELATED APPLICATION(S)

This U.S. non-provisional application is a continuation application of PCT International Application PCT/KR2024/001405, which has an International filing date of Jan. 30, 2024, and claims priority under 35 U.S.C. 119 to Korean Patent Application Nos. 10-2023-0020158, filed on Feb. 15, 2023, and 10-2024-0012263, filed on Jan. 26, 2024, in the Korean intellectual property office, the disclosures of which are herein incorporated by reference in its entirety.

### BACKGROUND

### 1. Field of the Invention

The present disclosure relates to technology related to a method and apparatus for double writing based on write-ahead, and more particularly, to technology that enables writes to be sequentially recorded in a storage when write order constraints occur between threads or streams.

### 2. Description of the Related Art

In general, a host sets an order-guaranteed command flag to a write request for a stream to ensure that the write order between streams is guaranteed. That is, if the order-guaranteed command flag is set to the write request for any stream by the host, the stream is permanently recorded in a storage before other streams. However, this approach only guarantees the write order between a corresponding write request and write requests that arrive thereafter. Therefore, there is a need for technology that may satisfy order constraints without wasting the space of a write command.

### SUMMARY

The present disclosure enables writes to be sequentially recorded in a storage when write order constraints occur between threads or streams. The present disclosure may guarantee the order even when n threads (n denoting an integer greater than or equal to 2) having a write request generated in a single thread and write order constraints.

The present disclosure provides a method and apparatus for double writing based on write-ahead.

In the present disclosure, a method for double writing based on write-ahead by a computer device may include classifying write requests for different streams into write-ahead and write-behind according to order constraints; making the write-ahead a double write for the streams; and recording the streams to meet the order constraints based on the double write.

In the present disclosure, a computer device for double writing based on write-ahead may include a storage; and a processor configured to connect to the storage, and to execute at least one instruction stored in the storage, and the processor may be configured to classify write requests for different streams into write-ahead and write-behind according to order constraints, to make the write-ahead a double write for the streams, and to record the streams to meet the order constraints based on the double write.

In the present disclosure, a computer program may be stored in a non-transitory computer-readable recording medium to execute a method for double writing based on write-ahead on a computer device, and the method for double writing based on write-ahead may include classifying write requests for different streams into write-ahead and write-behind according to order constraints; making the write-ahead to a double write for the streams; and recording the streams to meet the order constraints based on the double write.

The present disclosure satisfies n:1 write order constraints by making a write-ahead request a dual-stream write. Although n:1 order constraints occur, the corresponding order constraints may be satisfied by assigning two pairs of stream and epoch IDs to each write request. This has the effect of satisfying the order constraints without wasting space in a write command. As a technique compared to a double write-ahead presented herein, a double write-behind technique may satisfy the n:1 order constraints. The double write-behind technique relates to additionally assigning n stream and epoch ID pairs to a write-behind request rather than a write-ahead request. In the double write-behind technique, all writes-ahead belong to a single stream and writes-behind belong to n+1 streams. The double write-behind technique may also satisfy n:1 order constraints. However, since n+1 stream and epoch ID pairs need to be assigned to writes-behind, it may be difficult to assign all ID pairs to space-constrained write commands. The double write-ahead technique presented herein may guarantee n:1 write order constraints by assigning two stream and epoch ID pairs and may more economically use the space of write commands.

### BRIEF DESCRIPTION OF THE DRAWINGS

FIG. 1 is a diagram illustrating a schematic configuration of a computer device 100 for double writing based on write-ahead according to various example embodiments.

FIG. 2 is a diagram illustrating a detailed configuration of a processor of FIG. 1.

FIG. 3 is a flowchart illustrating a method for double writing based on write-ahead according to various example embodiments.

FIG. 4 is a diagram for exemplarily describing the method for double writing based on write-ahead of FIG. 3.

### DETAILED DESCRIPTION

The present disclosure proposes a method of expressing corresponding order constraints in the command of write requests when two write requests having constraints that they need to be recorded in a storage in specific order belong to different streams. In the present disclosure, a set of write requests generated by the same thread is defined as a stream. Write requests in each stream are grouped into epochs according to order constraints. The order in which write requests belonging to the same epoch in each stream are recorded may change. Write requests belonging to different epochs need to be recorded in order in which the epochs were generated. An input/output stack proposed in the present disclosure classifies write requests generated in a system into streams and epochs, and assign unique IDs to the streams and the epochs. Stream and epoch IDs belonging to a corresponding write request is assigned to the write request. The stream ID and the epoch ID represent order constraints of the write request.

When two write requests belonging to different streams have specific order constraints, the present disclosure defines a write to precede as write-ahead and a write to follow as write-behind. The present disclosure stores two pieces of order constraints information in the write-ahead. The first is order constraints in a stream to which the write-ahead originally belongs.

The second is order constraints information with write-behind. To this end, the present invention includes two stream and epoch ID pairs in the command of write requests. This is defined as a double write.

### <Input/Output Stack>

A file system presented in the present disclosure sets [ordered flag] and [barrier flag] according to an order constraint condition corresponding to a generated write request and transmits the same to a block input/output layer. The block input/output layer assigns two stream and epoch ID pairs, [first stream ID, first epoch ID] and [second stream ID, second epoch ID], to write requests based on the following information. The block input/output layer presented in the present disclosure assigns a process ID of a thread that generated a write request as a first stream ID and an epoch counter value of the thread as a first epoch ID to all write requests for which write order needs to be guaranteed. The present disclosure sets a second stream ID and a second epoch ID of a write request that needs to be recorded in a storage first, when order constraints are present between write requests belonging to different streams. In this case, a preceding write request belongs to both a stream that generated a corresponding write request and a stream that generated a following write request. The present invention defines a write request belonging to two streams as a dual-stream write. A technique of setting a write-ahead request as a dual-stream write is called a precedence-based dual-stream write. Also, a write request that belongs only to a stream of a thread that generated a corresponding write request is called a single-stream write. In the case of the single-stream write, second stream and second epoch IDs are not set.

### <Precedence-Based Dual-Stream Write>

When write requests generated by different threads have write order constraints, an ID of a stream to which a write-behind request belongs is assigned to a second stream ID of a write-ahead request and an epoch counter value of the thread that generates the write-behind request is assigned to a second epoch ID. In the case of transmitting the write-ahead request with a barrier flag set, the block input/output layer presented in the present disclosure assigns both two pairs of stream and epoch IDs to the write request and increases both an epoch counter value corresponding to a first stream and an epoch counter value corresponding to a second stream by 1. A second stream ID and a second epoch ID of the write-behind request are not set (values are 0). The write-behind request is a single-stream write that belongs only to a stream of a thread having generated the write request.

The file system presented in the present disclosure transmits, to the block input/output layer through the flag, information that a write-ahead request needs to be a dual-stream write when the write order needs to be guaranteed between write requests generated by different threads. An example of a case in which the write order needs to be guaranteed between write requests generated by different threads includes order constraints that, in EXT4 file system, a write request for a dirty page generated by a file system thread needs to be permanently recorded in a storage before a write request for a journal commit block generated by a journaling thread (JBD).

A device driver presented in the present disclosure stores [first stream ID, first epoch ID], [second stream ID, second epoch ID] assigned to a write request by the block input/output layer in an unused space of write command and transmits the same to a storage device.

### <n:1 Order Constraints>

In some cases, write requests generated by a plurality of threads need to be recorded before a write request generated by another one thread. For example, there are order constraints that, in the EXT4 file system, when threads calling an fsync( ) system call share the same running transaction, write requests for dirty pages generated by the threads need to be permanently recorded in a storage device before a write request for a journal commit block generated by a journaling thread. The present disclosure defines the corresponding phenomenon as n:1 order constraints. The input/output layer presented in the present disclosure makes all preceding n write requests as dual-stream writes in this situation. First stream and first epoch IDs of n write requests are assigned with a process ID and an epoch counter value of each thread, and second stream and second epoch IDs are assigned with an epoch counter value and an ID of a stream to which all writes-behind belong in n write requests.

Hereinafter, various example embodiments of the present disclosure are described with reference to the accompanying drawings.

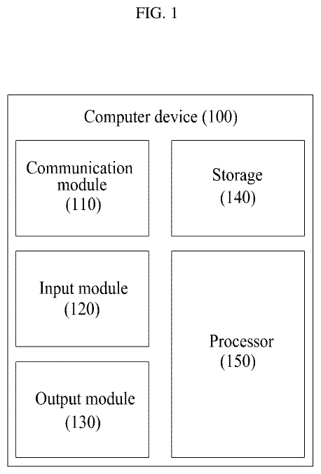

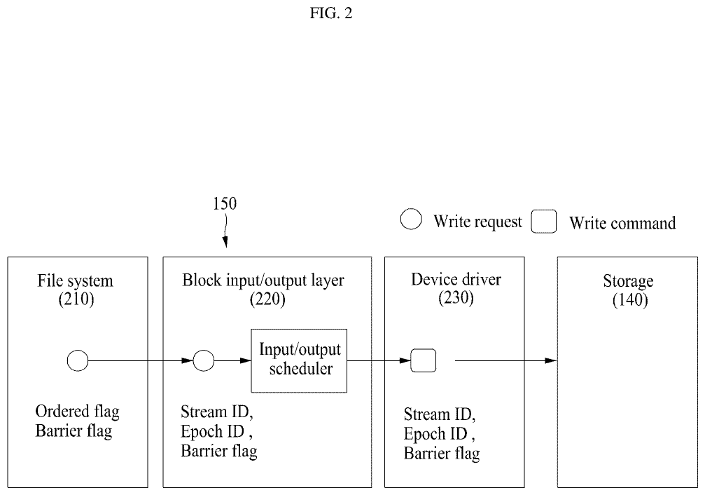

FIG. 1 is a diagram illustrating a schematic configuration of a computer device 100 for double writing based on write-ahead according to various example embodiments. FIG. 2 is a diagram illustrating a detailed configuration of a processor 150 of FIG. 1.

Referring to FIG. 1, the computer device 100 relates to double write based on write-ahead, and may include at least one of a communication module 110, an input module 120, an output module 130, a storage 140, and the processor 150. In some example embodiments, at least one (e.g., input module 120, output module 130) of the components of the computer device 100 may be omitted and at least one another component may be added. In some example embodiments, at least two of the components of the computer device 100 may be implemented as a single integrated circuit.

The communication module 110 may perform communication with an external device in the computer device 100. The communication module 110 may establish a communication channel between the computer device 100 and the external device, and may perform communication with the external device through the communication channel. Here, the external device may include at least one of another computer device, a base station, and a server. The communication module 110 may include at least one of a wired communication module and a wireless communication module. The wired communication module may be connected to the external device in a wired manner and may perform communication in a wired manner. The wireless communication module may include at least one of a near-field communication module and a far-field communication module. The near-field communication module may perform communication with the external device using a near-field communication method. For example, the near-field communication method may include at least one of Bluetooth, wireless fidelity (WiFi) direct, and infrared data association (IrDA). The far-field communication module may communicate with the external device using a far-field communication method. Here, the far-field communication module may communicate with the external device over a network. For example, the network may include at least one of a cellular network, the Internet, and a computer network such as a local area network (LAN) and a wide area network (WAN).

The input module 120 may input a signal to be used to at least one component of the computer device 100. The input module 120 may be configured to generate a signal by detecting a signal directly input from a user or by detecting a change in surroundings. For example, the input module 120 may include at least one of a mouse, a keypad, a microphone, and a sensing module having at least one sensor. In some example embodiments, the input module 120 may include at least one of a touch circuitry configured to detect a touch and a sensor circuitry configured to measure strength of force generated by the touch.

The output module 130 may output information to the outside of the computer device 100. The output module 130 may include at least one of a display module configured to visually output information and an audio output module configured to output information as an audio signal. For example, the audio output module may include at least one of a speaker and a receiver.

The storage 140 may store a variety of data. For example, the storage 140 may include at least one of a volatile memory and a nonvolatile memory. Data may include at least one program and input data or output data related thereto. The program may be stored in the storage 140 as a software that includes at least one command, and may include at least one of an operating system (OS), middleware, and an application.

The processor 150 may control at least one component of the computer device 100 by executing the program of the storage 140. Through this, the processor 150 may perform data processing or operation. Here, the processor 150 may execute the command stored in the storage 140. In detail, as shown in FIG. 2, the processor 150 may include a file system 210, a block input/output layer 220, and a device driver 230.

The file system 210 may set an ordered flag and a barrier flag according to order constraints of write requests for different streams.

The block input/output layer 220 may classify write requests into write-ahead and write-behind according to order constraints and may make the write-ahead as a double write for streams. The streams may be classified into a leader stream and a follower stream according to the order constraints. Here, the order constraints have two constraint conditions. The first constraint condition relates to the leader stream and the second constraint condition relates to between the leader stream and the follower stream. The block input/output layer 220 may divide the leader stream into a leader epoch and a remaining epoch after the leader epoch, and may define the follower stream with a follower epoch after the same leader epoch. The block input/output layer 220 may make the write-ahead a double write, by generating a leader ID pair of a leader stream and a leader epoch within the leader stream ([first stream ID, first epoch ID]), and a follower ID pair of a follower stream and a follower epoch within the leader stream ([second stream ID, second epoch ID]) and by setting the same within a command of the write-ahead.

The device driver 230 may record streams in the storage 140 to satisfy the order constraints based on a double write. In detail, the device driver 230 may verify the order constraints for streams from the double write and may record each of the streams in the storage 140 to meet the order constraints. That is, the device driver 230 may record a leader epoch and then record a remaining epoch for a leader stream, and may record a leader epoch and then record a follower epoch for a follower stream.

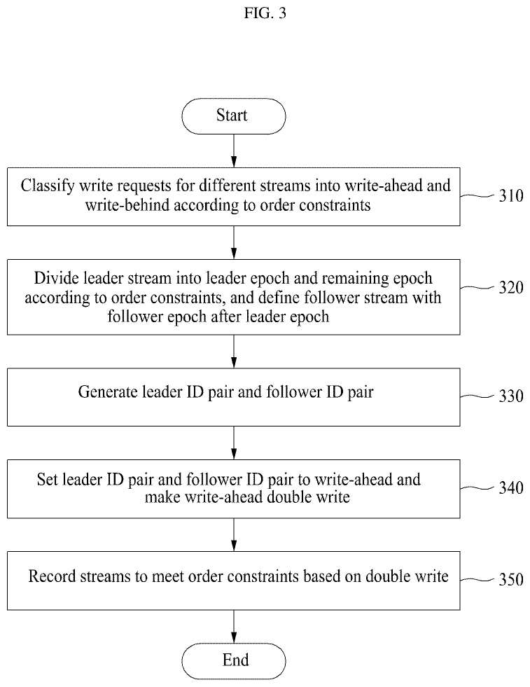

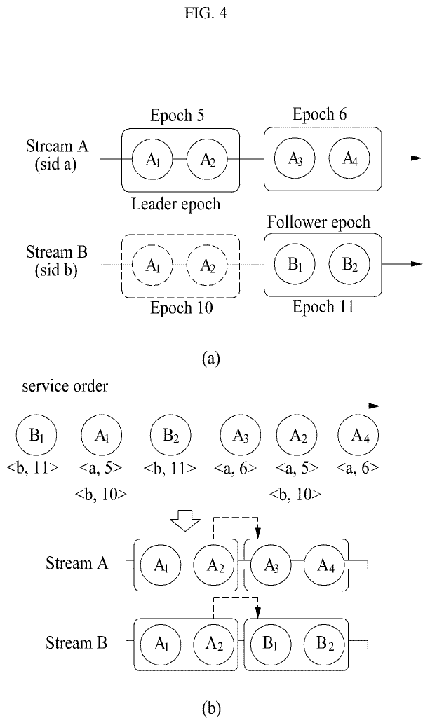

FIG. 3 is a flowchart illustrating a method for double writing based on write-ahead of the computer device 100 according to various example embodiments. FIG. 4 is a diagram for exemplarily describing the method for double writing based on write-ahead of FIG. 3.

Referring to FIG. 3, in operation 310, the processor 150 may classify write requests for different streams into write-ahead and write-behind according to order constraints. Here, among the write requests, a write request that precedes may be write-ahead and a write request following the write-ahead may be write-behind. Streams may be classified into a leader stream (Stream A) corresponding to the write-ahead and a follower stream (Stream B) corresponding to the write-behind according to the order constraints. Here, the order constraints may have two types of constraint conditions, and the first constraint condition may relate to the leader stream (Stream A), and the second constraint condition may relate to between the leader stream (Stream A) and the follower stream (Stream B).

Then, in operation 320, the processor 150 may divide the leader stream into a leader epoch and a remaining epoch after the leader epoch according to the order constraints, and may define the follower stream with a follower epoch after the leader epoch. In detail, the leader stream may include the leader epoch and the remaining epoch, and the follower stream may include the follower epoch. Here, according to the order constraints, the leader epoch may be the previous order of the remaining epoch and the follower epoch. Therefore, the processor 150 may divide the leader stream into the leader epoch and the remaining epoch according to the order constraints, and may define the follower stream with the follower epoch after the leader epoch.

For example, as shown in (a) of FIG. 4, a leader stream may include two epochs, that is, {A₁, A₂} and {A₃, A₄}, and a follower stream may include a single epoch, that is, {B₁, B₂}. According to the order constraints, the first constraint condition may be {A₁, A₂}→{A₃, A₄}, and the second constraint condition may be {A₁, A₂}→{B₁, B₂}. In this case, {A₁, A₂} may be simultaneously defined as the leader epoch for the leader stream and the follower stream, and {B₁, B₂} may be defined as the follower epoch for the follower stream. Therefore, the leader stream may be divided into two epochs, that is, {A₁, A₂} and {A₃, A₄}, and the follower stream may be defined with two epochs, that is, {A₁, A₂} and {B₁, B₂}.

In operation 330, the processor 150 may generate a leader ID pair related to the leader stream and a follower ID pair related to the follower stream. Here, the leader ID pair may include an ID of the leader stream and ID of the leader epoch within the leader stream. Meanwhile, the follower ID pair may include an ID of the follower stream and an ID of the leader epoch within the follower stream. In detail, the processor 150 may assign the ID of the leader stream and the ID of the leader epoch within the leader stream, and may assign the ID of the follower stream and the ID of the leader epoch within the follower stream. In the leader ID pair, the ID of the leader stream may be a process ID of a thread that generated write-ahead, and the ID of the leader epoch within the leader stream may be an epoch counter value of the thread that generated the write-ahead. In the follower ID pair, the ID of the follower stream may be a process ID of a thread that generated write-behind, and the ID of the leader epoch within the follower stream may be an epoch counter value of the thread that generated the write-behind. In addition, the processor 150 may assign the ID of the remaining epoch within the leader stream and the ID of the follower epoch within the follower stream. The ID of the remaining epoch within the leader stream may be a value increased by 1 from the ID of the leader epoch within the leader stream, and the ID of the follower epoch within the follower stream may be a value increased by 1 from the ID of the leader epoch within the follower stream.

Continuing, in operation 340, the processor 150 may set the leader ID pair and the follower ID pair to the write-ahead and may make the write-ahead a double write. In detail, the process 150 may set the leader ID pair and the follower ID pair within the command of the write-ahead.

For example, as shown in (a) of FIG. 4, the processor 150 may generate the leader ID pair, that is, <a, 5> with the ID of the leader stream and the ID of the leader epoch within the leader stream, and may generate the follower ID pair, that is, <b, 10> with the ID of the follower stream and the ID of the leader epoch within the follower stream. Through this, the processor 150 may set <a, 5> and <b, 10> within the command of the write-ahead and may make the write-ahead a double write. Meanwhile, the processor 150 may generate a remaining ID pair, that is, <a, 6> with the ID of the leader stream and the ID of the remaining epoch within the leader stream, and may generate an additional ID pair, that is, <b, 11> with the ID of the follower stream and the ID of the follower epoch within the follower stream.

Finally, in operation 350, the processor 150 may record streams to meet order constraints based on the double write. In detail, the processor 150 may verify order constraints for streams from the double write, and may record each of the streams in the storage 140 to satisfy the order constraints. That is, the processor 150 may record the leader epoch and then record the remaining epoch for the leader stream, and may record the leader epoch and then record the follower epoch for the follower stream.

For example, as shown in (b) of FIG. 4, although data within streams is serviced in random order, the processor 150 may record the streams to meet the order constraints based on the double write. The processor 150 may record A₁ and A₂ corresponding to the leader epoch of the leader stream and then may record A₃ and A₄ corresponding to the remaining epoch of the leader stream. In addition, after A₁ and A₂ corresponding to the leader epoch of the leader stream are recorded, the processor 150 may record B₁ and B₂ corresponding to the follower epoch of the follower stream.

As described above, the present disclosure satisfies n:1 write order constraints by making a write-ahead request a dual-stream write. Although n:1 order constraints occur, the corresponding order constraints may be satisfied by assigning two pairs of stream and epoch IDs to each write request. This has the effect of satisfying the order constraints without wasting space in a write command. As a technique compared to a double write-ahead presented herein, a double write-behind technique may satisfy the n:1 order constraints. The double write-behind technique relates to additionally assigning n stream and epoch ID pairs to a write-behind request rather than a write-ahead request. In the double write-behind technique, all writes-ahead belong to a single stream and writes-behind belong to n+1 streams. The double write-behind technique may also satisfy n:1 order constraints. However, since n+1 stream and epoch ID pairs need to be assigned to writes-behind, it may be difficult to assign all ID pairs to space-constrained write commands. The double write-ahead technique presented herein may guarantee n:1 write order constraints by assigning two stream and epoch ID pairs and may more economically use the space of write commands.

The apparatuses described herein may be implemented using hardware components, software components, and/or the combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, or a computer storage medium or device to be interpreted by the processing device or to provide an instruction or data to the processing device. The software also may be distributed over network coupled computer systems so that the software is stored and executed in a distributed fashion. The software and data may be stored by one or more computer readable storage media.

The methods according to various example embodiments may be configured in a form of program instructions that may be performed through various computer methods and recorded in computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Also, examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

According to various example embodiments, each of the aforementioned components (e.g., module or program) may include a singular object or a plurality of objects. According to various example embodiments, among the aforementioned components, one or more components or operations may be omitted or one or more other components or operations may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by modules, programs, or other components may be executed sequentially, in parallel, iteratively, or heuristically, or one or more of the operations may be executed in different order or omitted, or one or more other operations may be added.

What is claimed is:

1. A method for double writing based on write-ahead by a computer device, the method comprising:
classifying write requests for different streams into write-ahead and write-behind according to order constraints;
making the write-ahead a double write for the streams; and
recording the streams to meet the order constraints based on the double write.

2. The method of claim 1, wherein the streams are classified into a leader stream and a follower stream according to the order constraints, and
the order constraints include a constraint condition within the leader stream, and a constraint condition between the leader stream and the follower stream.

3. The method of claim 2, wherein the making the double write comprises:
dividing the leader stream into a leader epoch and a remaining epoch after the leader epoch according to the order constraints, and defining the follower stream with a follower epoch after the leader epoch; and
setting, to the write-ahead, a leader ID pair of the leader stream and the leader epoch within the leader stream and a follower ID pair of the follower stream and the leader epoch within the follower stream.

4. The method of claim 3, wherein, in the leader ID pair, an ID of the leader stream is a process ID of a thread that generated the write-ahead, and an ID of the leader epoch within the leader stream is an epoch counter value of the thread that generated the write-ahead,
in the follower ID pair, an ID of the follower stream is a process ID of a thread that generated the write-behind and an ID of the leader epoch within the follower stream is an epoch counter value of the thread that generated the write-behind,
an ID of the remaining epoch within the leader stream is a value increased by 1 from the ID of the leader epoch within the leader stream, and
an ID of the follower epoch within the follower stream is a value increased by 1 from the ID of the leader epoch within the follower stream.

5. The method of claim 1, wherein the recording of the streams comprises:
verifying the order constraints for the streams from the double write; and
recording each of the streams to meet the order constraints.

6. A computer device for double writing based on write-ahead, the computer device comprising:
a storage; and
a processor configured to connect to the storage, and to execute at least one instruction stored in the storage,
wherein the processor is configured to,
classify write requests for different streams into write-ahead and write-behind according to order constraints,
make the write-ahead a double write for the streams, and
record the streams to meet the order constraints based on the double write.

7. The computer device of claim 6, wherein the streams are classified into a leader stream and a follower stream according to the order constraints, and
the order constraints include a constraint condition within the leader stream, and a constraint condition between the leader stream and the follower stream.

8. The computer device of claim 7, wherein the processor is configured to,
divide the leader stream into a leader epoch and a remaining epoch after the leader epoch according to the order constraints, and define the follower stream with a follower epoch after the leader epoch, and
setting, to the write-ahead, a leader ID pair of the leader stream and the leader epoch within the leader stream and a follower ID pair of the follower stream and the leader epoch within the follower stream.

9. The computer device of claim 8, wherein, in the leader ID pair, an ID of the leader stream is a process ID of a thread that generated the write-ahead, and an ID of the leader epoch within the leader stream is an epoch counter value of the thread of the write-ahead,
in the follower ID pair, an ID of the follower stream is a process ID of a thread that generated the write-behind and an ID of the leader epoch within the follower stream is an epoch counter value of the thread of the write-behind,
an ID of the remaining epoch within the leader stream is a value increased by 1 from the ID of the leader epoch within the leader stream, and
an ID of the follower epoch within the follower stream is a value increased by 1 from the ID of the leader epoch within the follower stream.

10. A non-transitory computer-readable recording medium in which a computer program for executing a method for double writing based on write-ahead on a computer device is recorded, wherein the method comprises:
classifying write requests for different streams into write-ahead and write-behind according to order constraints;
making the write-ahead to a double write for the streams; and
recording the streams to meet the order constraints based on the double write.
